(19) United States
(12) Patent Application Publication
(10) Pub. No.: US 2026/0230425 A1
(43) Pub. Date: Aug. 6, 2026

(54) CONTROLLING TRANSFER OF CONFIGURATION INFORMATION

(71) Applicant: Siemens Mobility GmbH, München (DE)

(72) Inventors: Andreas Zirkler, Ottobrunn (DE); Vitali Schneider, Neunkirchen am Sand (DE); Rainer Mattes, Trittenheim (DE); Rudolf Neite, Forchheim (DE); Harald Rölle, Putzbrunn/Oedenstockach (DE); Michael Kirsche, Berlin (DE)

(21) Appl. No.: 19/152,119

(22) PCT Filed: Dec. 27, 2023
(86) PCT No.: PCT/EP2023/087812

§ 371 Date: Jul. 30, 2025

(30) Foreign Application Priority Data
Jan. 30, 2023 (DE) 10 2023 200 713.4

(51) Int. Cl. H04L 45/28; H04L 45/02

(52) U.S. Cl. CPC H04L 45/28; H04L 45/02

(57) ABSTRACT

A method for operating an Ethernet network in which configuration information is forwarded. The transfer of configuration information relating to an operation of network bridges of the Ethernet network is controlled. In particular the transfer of bridge protocol data units (BPDU) of a spanning tree protocol is controlled.

The invention relates to a method for operating an Ethernet network, an Ethernet network, a computer program, and a computer-readable medium.

Computer networks are often constructed as Ethernet networks for the purpose of exchanging data. This means that both the physical layer of the OSI model (Layer 1) and the data link layer of the OSI model (Layer 2) are defined. Such computer networks comprise numerous network bridges that provide multiple possible paths for the transmission of data packets. In order to ensure that a unique communication connection can be established between two communication participants in the computer network, a key task is to maintain a network topology free of redundant paths and loops. For this purpose, the Spanning Tree Protocol (STP) or its enhancements, such as RSTP (Rapid Spanning Tree Protocol) or MSTP (Multiple Spanning Tree Protocol), are already known. A network topology in which redundant paths exist is converted into a tree topology using the aforementioned protocols. This eliminates redundant paths.

A key aspect of the Spanning Tree Protocol is the selection, from the aforementioned network bridges, of a so-called root bridge through which all data packets are transmitted. According to the Spanning Tree Protocol, the network bridge with the highest priority is selected as the root bridge. If two network bridges with the same priority are both candidates for selection as the root bridge, the network bridge with the smallest MAC address is selected as the root bridge. In the event of failure of a root bridge selected in this way, a new root bridge is selected from the remaining network bridges on the basis of the above criteria. However, the process for selecting a new root bridge is time-consuming, depending on the network topology. During the search for a new root bridge, no communication can take place via the Ethernet network. Root bridge failure therefore results in a failure of data transmission. This poses a significant risk in terms of availability, particularly in time-critical applications. To reduce this risk, it is already known to use predefined network topologies, such as a ring topology, to enable a new root bridge to be found quickly. However, for mixed network topologies, such as an H-topology or a ladder topology, no method has yet been developed that allows a new root bridge to be identified sufficiently quickly. In particular, when using the aforementioned RSTP, mixed network topologies cause significant delays in finding a new root bridge.

The object of the invention is to improve the availability and reliability of a computer network.

This object is achieved by a method according to the features of claim 1.

The object of the invention is also to provide an Ethernet network by means of which the method according to the invention can be carried out.

This object is achieved by an Ethernet network according to the features of the independent device claim.

The object of the invention is also to provide a computer program and a computer-readable medium.

These objects are achieved by a computer program according to the features of the independent computer program claim and by a computer-readable medium according to the features of the independent claim 15.

Advantageous further developments of the invention are set forth in the dependent subclaims.

The method according to the invention relates to the operation of an Ethernet network. In the inventive method, the forwarding of configuration information relating to the operation of network bridges within the Ethernet network is controlled. The configuration information includes in particular, so-called “Bridge Protocol Data Units” of a Spanning Tree Protocol. These Bridge Protocol Data Units are commonly abbreviated using the acronym “BPDU”. In the present context, network bridges are to be understood as connection elements within the network that are used to transmit data at the second level of the OSI reference model. In particular, the network bridges are implemented as so-called MAC bridges. The network bridges advantageously include a microcontroller, a processor or another programmable hardware component designed to read, write, transmit and/or manage data.

The Spanning Tree Protocol is a well-known network protocol. In this context, the term also encompasses enhancements such as the Rapid Spanning Tree Protocol (RSTP) or the Multiple Spanning Tree Protocol (MSTP). The purpose of the Spanning Tree Protocol is to achieve a loop-free network topology.

Here, the term network topology refers to the signal topology of an Ethernet network based on the first layer of the OSI reference model. Examples of network topologies include ring, star, or H-topologies, as well as combinations thereof.

The method according to the invention provides a time- and resource-efficient means of improving network communication based on supplementing or modifying a Spanning Tree Protocol. In this way, downtimes affecting mixed network topologies can be significantly reduced by slightly modifying the Spanning Tree Protocol. In addition, it eliminates the need to create alternative protocols and convert existing networks. This ensures a high degree of compatibility with existing networks.

An advantageous further development provides that forwarding of configuration information is controlled based on information concerning the priority of the sender of the configuration information. Usually, a network bridge that is assigned a high reference value has a lower priority than a network bridge assigned a comparatively smaller reference value. Sender priority information that is already contained by default in configuration information can be easily used to control the forwarding. This prevents an increase in data traffic and the resulting network load caused by additional volumes of data.

In another advantageous embodiment, it is provided that forwarding of configuration information is controlled based on a predetermined priority threshold value. Configuration information from a sender having a priority lower than the priority threshold value can thus be easily excluded from the forwarding. The volume of configuration information to be forwarded can therefore be reduced in a time- and resource-efficient and requirement-based manner.

Another advantageous embodiment provides that forwarding of configuration information is controlled based on information about a change in the network topology. A change in the network topology can occur when network participants are added to or removed from the Ethernet network. A change in the network topology can also occur, for example, when a network participant unexpectedly fails. A particularly extensive change in the network topology occurs when a root bridge fails. A procedure that deviates from the standard Spanning Tree Protocol (STP) procedure can thus be limited to cases where changes in network topology are present. In this way, the efficiency of the method for controlling forwarding can be increased in a time- and resource-efficient manner.

In an advantageous variant, it is provided that forwarding of configuration information is controlled based on information about a root bridge failure. This allows deviation from the standard STP procedure only when a fundamental and significant change in the network topology occurs. Moreover, forwarding of configuration information originating from the failed root bridge can be easily stopped after its failure. In the event of failure of the root bridge, a new root bridge can thus be selected particularly quickly. Also, misinterpretations regarding configuration information originating from the failed root bridge can be easily prevented.

A further advantageous development also provides that, in the event of failure of a root bridge, information regarding the failure of the root bridge is forwarded via other network bridges of the Ethernet network. A network bridge that receives the information about the failure of the root bridge is placed into a separate operating state. Based on said separate operating state, filters can be easily implemented for the purpose of accelerating the identification of a new root bridge. Downtimes of the communication network can thus be easily reduced.

In an advantageous variant, it is provided that, in the separate operating state, a network bridge only forwards configuration information transmitted by a sender having a priority greater than that of senders of configuration information already received by the network bridge during the separate operating state. Advantageously, the network bridge stores the priorities of senders of already received configuration information in the separate operating state. As a result, the amount of configuration information to be processed by subsequent network bridges can be easily and effectively reduced. This shortens processing time and can thereby accelerate the identification of a new root bridge.

A further advantageous embodiment provides that, in the separate operating state, a network bridge only forwards configuration information transmitted by a sender having a priority that is lower than the priority assigned to the failed root bridge. Configuration information originating from the failed root bridge that continues to be forwarded within the Ethernet network after the failure can thus be easily disregarded. Erroneous configuration of individual network bridges due to the intentionally high priority of the root bridge can thus be reliably prevented.

Furthermore, an advantageous variant relates to the case where configuration information is received from a sender assigned the same priority as a sender of configuration information that has already been received and forwarded. In this case, it is proposed that forwarding be based on information relating to associated path costs. The configuration information to be forwarded is preferably only forwarded if the associated path costs are lower than the path costs associated with the configuration information that has already been forwarded. This further increases the efficiency of the method.

Another advantageous embodiment provides that, starting from the time at which the information relating to the failure of the root bridge is received, a network bridge is placed into the separate operating state for a predetermined period of time. In this way, intervention in a program code of already implemented protocols can be kept to a minimum. Furthermore, a particularly fast and time-efficient method for resuming communication via the Ethernet network can be realized in this way.

In an advantageous embodiment, the network bridge is placed into the separate operating state for a period of no more than 10 seconds, preferably no more than 8 seconds, and with particular preference no more than 4 seconds, starting from the time at which the information relating to the failure of the root bridge is received.

Another advantageous embodiment provides that forwarding of configuration information is controlled on the basis of information relating to the position of a failed root bridge in the Ethernet network. Provided that the network topology is known, configuration information originating from the root bridge can be easily filtered out in the event of failure of said root bridge. Forwarding of configuration information originating from the failed root bridge can thus be easily and efficiently prevented. For example, runtimes or path costs can be used to control the forwarding of configuration information.

A further advantageous embodiment provides that forwarding of configuration information is controlled based on information concerning the direction of origin of the configuration information. Knowledge of the structure of an existing network topology can be used to disregard configuration information that originates from a failed root bridge and continues to be forwarded within the Ethernet network after a failure. Configuration information forwarded by network bridges following failure of a root bridge can thus be easily identified based on direction of origin. This can significantly speed up the process of finding a new root bridge. Furthermore, it effectively prevents configuration information from the failed root bridge from being mistakenly accepted by individual network bridges.

Moreover, the method according to the invention is preferably a computer-implemented method for operating an Ethernet network.

The method according to the invention can be carried out by means of the Ethernet network according to the invention.

The Ethernet network according to the invention has a plurality of network bridges which are designed to carry out the method according to the invention.

In this way, a network can be implemented in a resource-efficient manner for operating time-critical applications.

Network downtimes can thus be significantly reduced. Furthermore, existing networks can be easily expanded and improved.

The invention also provides a computer program which, when executed, causes the Ethernet network according to the invention to carry out the inventive method.

The present invention also provides a computer-readable medium. This contains instructions which cause the Ethernet network according to the invention to carry out the method according to the invention. The computer-readable medium may be, for example, a CD-ROM, a DVD, a USB or flash memory, or a non-physical medium such as a data stream and/or a data carrier signal.

The properties, features, and advantages of the invention described above, as well as the manner in which they are achieved, will be explained in greater detail in the following description of embodiments of the invention in conjunction with the accompanying figures. Where appropriate, the same reference characters are used in the figures to denote the same or corresponding elements of the invention. The following exemplary embodiment, and described variations therefrom, serve to explain the invention and do not limit the invention to the combinations of features specified therein, including with regard to functional features. In addition, all features specified in the exemplary embodiment can be considered in isolation and combined, as appropriate, with the features of any claim.

In the drawings:

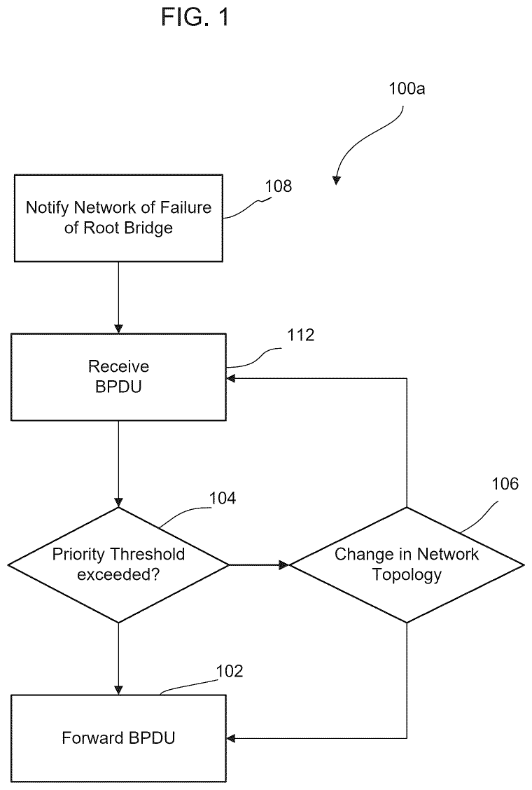

FIG. 1 schematically illustrates a first example of the method according to the invention;

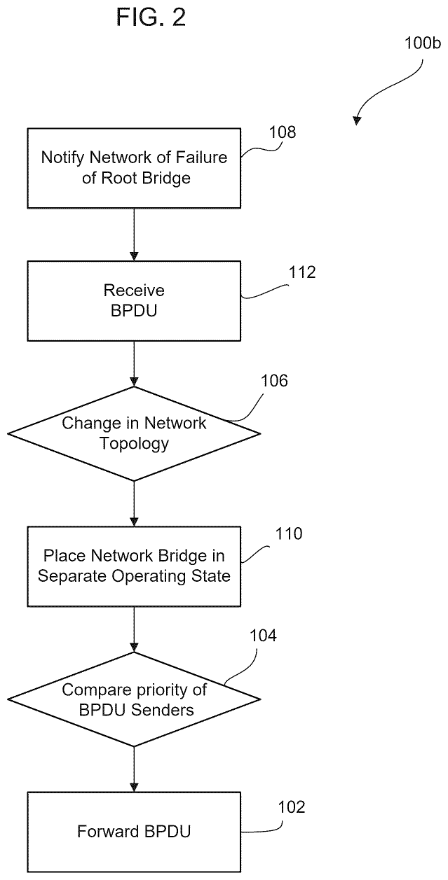

FIG. 2 schematically illustrates a second example of the method according to the invention;

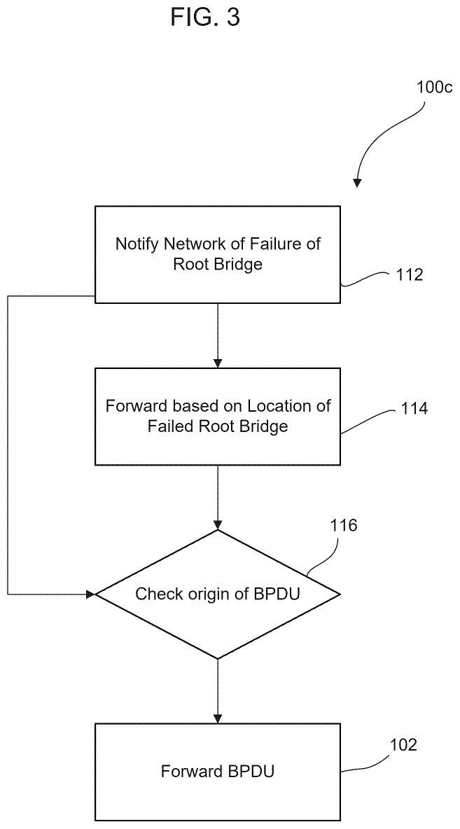

FIG. 3 schematically illustrates a third example of the method according to the invention;

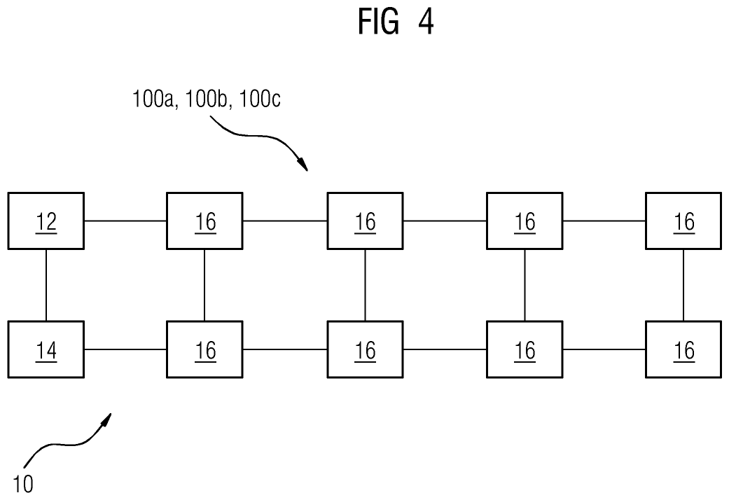

FIG. 4 shows an exemplary embodiment of the Ethernet network according to the invention, which is designed to carry out the method according to the invention.

FIG. 1 illustrates a first example of a method 100a for operating an Ethernet network 10. In this example of the method 100a, the already known Spanning Tree Protocol is modified such that forwarding 102 of configuration information relating to the operation of network bridges 12, 14, 16 of the Ethernet network 10 is controlled 104.

By way of example, the configuration information consists of so-called “Bridge Protocol Data Units” of a Spanning Tree Protocol. For the sake of clarity, the corresponding acronym BPDU will be used in the following. The first example of the method 100a provides that a priority threshold value is predefined for network bridges 14, 16 of the Ethernet network 10. In addition to a method specified by the Spanning Tree Protocol, the received BPDUs (indicated by 112) are checked on the basis of the predefined priority threshold value to determine whether a priority of a sender of the BPDU exceeds the priority threshold value 104. If the predefined priority threshold value is exceeded, the received BPDUs are forwarded 102 in accordance with the specifications of the Spanning Tree Protocol. If, on the other hand, the priority threshold value is not exceeded, a check is performed to determine whether information relating to a change in the network topology is present 106. In the first example of the method 100a described here, a change in the network topology is deemed to have occurred at least when a root bridge 12 fails.

In the event that the root bridge 12 fails, the first example of the method 100a provides that information relating to the failure of the root bridge 12 is forwarded 108 within the Ethernet network 10. If the aforementioned information relating to the failure of the root bridge 12 is received 112 by a network bridge 14, 16, the latter stores the aforementioned information. For example, the aforementioned information is stored by means of a status indicator.

If a network bridge 14, 16 has information indicating that the root bridge 12 has failed, BPDUs are forwarded 102 even if the sender has a priority that is lower than the predefined priority threshold value. Conversely, if a network bridge 14, 16 does not have information relating to the failure of the root bridge 12, then BPDUs that originate from a sender having a priority lower than the predefined priority threshold value are not forwarded 102, contrary to the standard specifications of the Spanning Tree Protocol.

According to the first example of the method 100a, forwarding 102 of BPDUs is thus controlled 104, 106 based on sender priority and on the basis of a change in network topology.

FIG. 2 illustrates a second example of a method 100b for operating an Ethernet network 10. The second example of method 100b, as illustrated in FIG. 2, represents a further development of the first example of the method 100a described in connection with FIG. 1. In contrast to the first example of the method 100a, no priority threshold value is predefined for the network bridges 14, 16. Instead, in the event that a network bridge 14 or 16 receives 112 information regarding the failure of the root bridge 12, it is placed into a separate operating state 110. For example, an affected network bridge 14, 16 is placed in the separate operating state 110 for a limited period of 10 seconds. In the second example of the method 100b, it is provided that, in the separate operating state 110, the network bridges 14, 16 only perform forwarding 102 of BPDUs from senders having a priority greater than the priorities of senders of BPDUs already received 112 by the network bridge 14, 16 during the separate operating state 110. In this way, a fixed priority threshold value can be dispensed with. Instead of the predefined priority threshold value, forwarding 102 of BPDUs is therefore controlled 104 based on a dynamic priority threshold value. This dynamic priority threshold value depends on the priorities of the senders of BPDUs already received 112. The second example of the method 100b also provides that, in the separate operating state 110, the network bridges 14 and 16 only forward 102 those BPDUs whose sender has a priority that is lower than the priority assigned to the failed root bridge 12.

In the special case where, during the separate operating state 110, BPDUs are received 112 by a network bridge 14, 16 from senders having the same priority value, the affected BPDUs are forwarded 102 based on information relating to associated path costs. For example, if BPDUs have already been received 112 from senders assigned the same priority as a currently received BPDU, the path costs of the BPDUs already forwarded 102 are compared with the path costs of the BPDUs currently received 112. If the BPDUs currently received 112 have lower path costs than the BPDUs already forwarded 102, the BPDUs currently received 112 are forwarded 102. If, on the other hand, the BPDUs currently received 112 have higher path costs than a BPDU already forwarded 102, the BPDUs currently received 112 are not forwarded 102.

FIG. 3 illustrates a third example of a method 100c for operating an Ethernet network 10. The third example of the method 100c, as illustrated in FIG. 3, can be applied alternatively or in addition to the previously described first example of the method 100a, as illustrated in FIG. 1, and/or to the previously described second example of the method 100b, as illustrated in FIG. 2.

The third example of the method 100c is based on knowledge of a network topology of the Ethernet network 10. On the basis of this knowledge, the position of the root bridge 12 and the positions of the other network bridges 14, 16 are known. In the third example of the method 100c described herein, forwarding 102 of BPDUs is controlled 114 based on knowledge of the relative positions of the network bridges 12, 14, 16.

For example, knowledge of the positions of network bridges 12, 14, 16 in the Ethernet network 10 is used such that forwarding 102 of the BPDUs is controlled 116 based on information relating to a direction of origin of the BPDUs.

For this purpose, the network topology of the Ethernet network 10 is preferably configured such that a root bridge 12 and another network bridge 14 immediately adjacent thereto are located on a predetermined side of the network topology. The other network bridge 14 is one that is assigned a priority on the basis of which it is selected as the new root bridge 14 in the event of failure of the root bridge 12.

As a rule, BPDUs originating from the root bridge 12 are forwarded 102 by the other network bridges 14, 16 of the Ethernet network 10 in accordance with the Spanning Tree Protocol. This means that, in meshed networks, individual BPDUs are duplicated. BPDUs from the same sender and having the same content can therefore be received 112 from different directions by a network bridge 12, 14, 16. Knowledge of the positions of the network bridges 12, 14, 16 relative to each other makes it possible to control 116 the forwarding of BPDUs based on their direction of origin.

To further illustrate the third example of the method 100c, an exemplary embodiment of an Ethernet network 10 is shown schematically in FIG. 4. By way of example, the Ethernet network 10 comprises a plurality of network bridges 12, 14, 16. The network bridges 12, 14, 16 are arranged in the form of an H-topology. The root bridge 12 and the aforementioned other network bridge 14 are positioned, by way of example, on the left-hand side of the schematic representation.

According to the third example of method 100c described in connection with FIG. 3, forwarding 102 of BPDUs from the root bridge 12 is prevented 116 as soon as they are received 112 by a network bridge 14, 16 from a direction from the right side of the schematic representation in FIG. 4. In contrast, BPDUs received 112 from a direction other than the right-hand side of FIG. 4 are forwarded 102 in accordance with the standard specifications of the Spanning Tree Protocol. In this way, forwarding 102 of BPDUs in the Ethernet network 10 shown by way of example in FIG. 4 is controlled 114, 116 based on the positions of the network bridges 12, 14, 16 and based on the direction of origin of a BPDU. It is conceivable that the aforementioned control 114, 116 is limited to cases in which the root bridge 12 has failed. Preferably, however, control 114, 116 of forwarding 102 based on positions of the network bridges 12, 14, 16 and direction of origin is implemented regardless of whether the root bridge 12 has failed.

For example, the Ethernet network 10 shown schematically in FIG. 4 is also designed to carry out the first example of the method 100a described in connection with FIG. 1 and the second example of the method 100b described in connection with FIG. 2. Combinations of the first example of the method 100a or the second example of the method 100b with the third example of the method 100c are also conceivable. Depending on the configuration, the Ethernet network 10 is typically designed to carry out the described methods 100a, 100b, 100c individually or in combination. Therefore, the network bridges 12, 14, 16 shown are, in particular, the network bridges 12, 14, 16 described in connection with FIG. 1, FIG. 2, and/or FIG. 3.

Although the invention has been illustrated and described in detail using the preferred embodiments, the invention is not limited by the disclosed examples, and other variations will be apparent to persons skilled in the art without departing from the scope of protection of the invention.

Independent of the grammatical term usage, individuals with male, female or other gender identities are included within the term.

1-15. (canceled)

16. A method of operating an Ethernet network, the method comprising:
controlling a forwarding of configuration information relating to an operation of network bridges of the Ethernet network and thereby controlling the forwarding of bridge protocol data units of a spanning tree protocol.

17. The method according to claim 16, which comprises controlling the forwarding of configuration information based on information relating to a priority of a sender of the configuration information.

18. The method according to claim 17, which comprises controlling the forwarding of configuration information based on a predefined priority threshold value.

19. The method according to claim 16, which comprises controlling the forwarding of configuration information based on information relating to a change in a network topology.

20. The method according to claim 19, which comprises controlling the forwarding of configuration information based on information relating to a failure of a root bridge.

21. The method according to claim 16, which comprises:
in an event of a failure of a root bridge, forwarding information relating to the failure of the root bridge by way of other network bridges of the Ethernet network; and
placing a respective network bridge which has received the information relating to the failure of the root bridge into a separate operating state.

22. The method according to claim 21, wherein a network bridge in the separate operating state only forwards configuration information from senders that are assigned a priority greater than priorities of senders of configuration information already received by the network bridge during the separate operating state.

23. The method according to claim 21, wherein a network bridge in the separate operating state only forwards configuration information from senders that are assigned a priority lower than a priority assigned to the failed root bridge.

24. The method according to claim 21, which comprises, when configuration information is received by a network bridge from senders that are assigned a same priority, forwarding the configuration information based on information relating to associated path costs.

25. The method according to claim 21, which comprises placing a network bridge in the separate operating state for a predetermined period of time from a time when the information relating to the failure of the root bridge is received.

26. The method according to claim 16, which comprises controlling the forwarding of configuration information based on information relating to a location of a failed root bridge.

27. The method according to claim 16, which comprises controlling the forwarding of configuration information based on information relating to a direction of origin of the configuration information.

28. An Ethernet network, comprising a plurality of network bridges configured to carry out the method according to claim 16.

29. A non-transitory computer program which, when executed, causes an Ethernet network with a plurality of network bridges to carry out the method according to claim 16.

30. A non-transitory computer-readable medium having instructions which cause an Ethernet network with a plurality of network bridges to carry out the method according to claim 16.
